(19) United States
(12) Patent Application Publication
(10) Pub. No.: US 2002/0111897 A1
(43) Pub. Date: Aug. 15, 2002

(54) Web-based method and implementation for procurement of goods and services

(76) Inventor: Richard L. Davis, Dallas, TX (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/044,430

(22) Filed: Jan. 11, 2002

Related U.S. Application Data
(60) Provisional application No. 60/261,317, filed on Jan. 12, 2001.

(51) Int. Cl. G06F 17/60

(52) U.S. Cl. 705/37

(57) ABSTRACT

A method and implementation are disclosed for management of a bid/auction, preferably a web-based or other type of electronically-enabled procurement process. The implementation performs the steps of the method, which includes receiving a request for quote including requirement information from a buyer for a predetermined transaction. The requirement information is packaged into a bid/auction presentation for the predetermined transaction. Buyers and sellers are able to communicate on the specifications of the goods or services in an open forum prior to the bid/auction process. A plurality of sellers are selected to each respectively provide at least one competitive bid for the predetermined transaction. The bid/auction presentation is displayed for inspection to the plurality of sellers. The bid/auction is moderated for a predetermined interval to enable the plurality of sellers to submit a plurality of competitive bids. The bid results are presented to the buyer for selection of winning bid from among the sellers.

### CROSS REFERENCE TO RELATED APPLICATION

The present application claims the benefit of U.S. Provisional Application No. 60/261,317 filed Jan.12, 2001.

### BACKGROUND OF THE INVENTION

The present invention is directed to the field of procurement of goods and services. In acquiring business to business goods and services, i.e. display fixtures, shipping services, and any other of a wide range of goods and services required in doing business, much time and effort must be spent in communicating with suppliers to obtain product information and competitive bids. This adds considerable overhead to the cost of doing business. These problems can be especially significant for conventional “bricks and mortar” retailers, and can thereby diminish competitiveness. It has thus been difficult for business buyers to make connections with sellers of goods and services who are able to provide the most suitable and economic services to satisfy the needs of the business, resulting in much inefficiency.

This situation also creates difficulties for the suppliers themselves, since an element of guesswork and luck can be involved in connecting with the customers desiring to procure their products and services. As with the buyer businesses, the seller businesses expend considerable time and effort to locate customers for their goods and services, which adds to the cost of doing business. It has therefore also been difficult for the sellers of goods and services to make connections with suitable customers, resulting in further inefficiency.

### SUMMARY OF THE INVENTION

These problems and others that result from previous methods are resolved in the herein-disclosed method and implementation for management of procurement bidding, which has particular applicability to web-based and other type of electronically-enabled auctions. The implementation performs the steps of the method, which includes receiving a request for quote including requirement information from a buyer for a predetermined transaction. The requirement information is packaged into a bid/auction presentation for the predetermined transaction. A plurality of sellers are selected to each respectively provide at least one competitive bid for the predetermined transaction. The bid/auction presentation is displayed for inspection to the plurality of sellers. The bid/auction is moderated for a predetermined interval to enable the plurality of sellers to submit a plurality of competitive bids. The bid results are presented to the buyer for selection of winning bid from among the sellers.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1 is a flow chart depicting the steps of the method of procurement in accordance with the present invention.

FIG. 2 is a block diagram showing a main sub-menu for a web site implementation in accordance with the present invention.

FIG. 3 is a block diagram showing a tree of linked web pages with menu options for a transaction manager section interface as a part of the procurement/auction web site in accordance with the present invention.

FIG. 4 is a block diagram showing a tree of linked web pages with menu options for a seller manager section interface as a part of the procurement/auction web site in accordance with the present invention.

FIG. 5 is a block diagram showing a tree of linked web pages with menu options for a buyer section interface as a part of the procurement/auction web site in accordance with the present invention.

### DETAILED DESCRIPTION OF THE INVENTION

The present invention provides a procurement process preferably implemented as an online bidding/auction, providing communication and procurement preferably through a protected web site. However, it should be appreciated that the present invention is not in any way limited to an online, web-based system, nor necessarily through any other network or other electronic medium, but can be implemented through any other type conventional business service methodology. The present invention preferably provides an automated method for connecting buyers and sellers of goods and services in an unbiased bidding/auction arena with real-time communication capabilities. The invention simplifies the procurement process while cutting down expensive communication costs and providing buyers with more competitive bids from the most qualified suppliers.

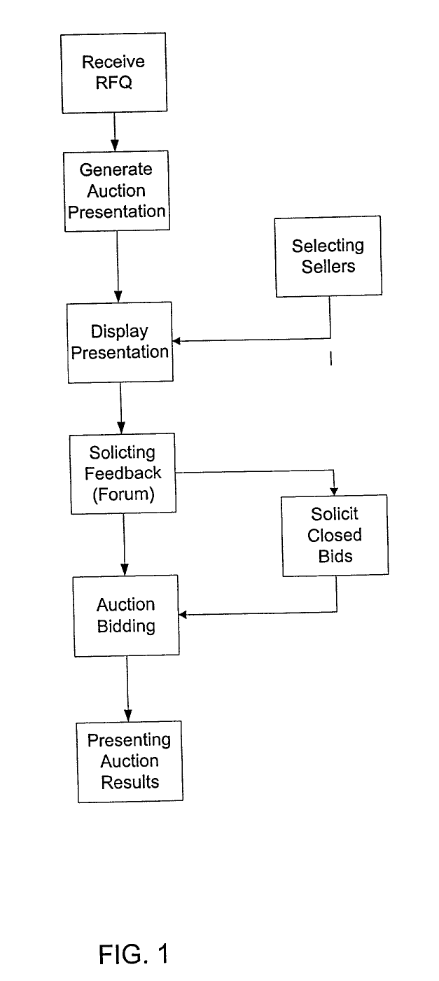

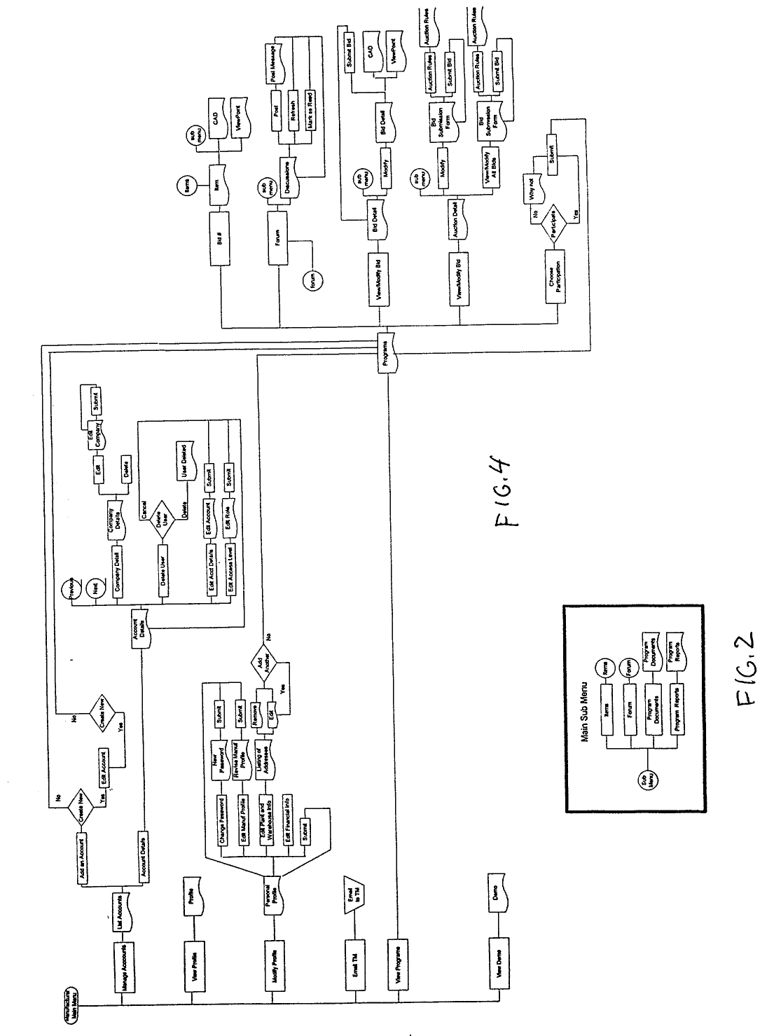

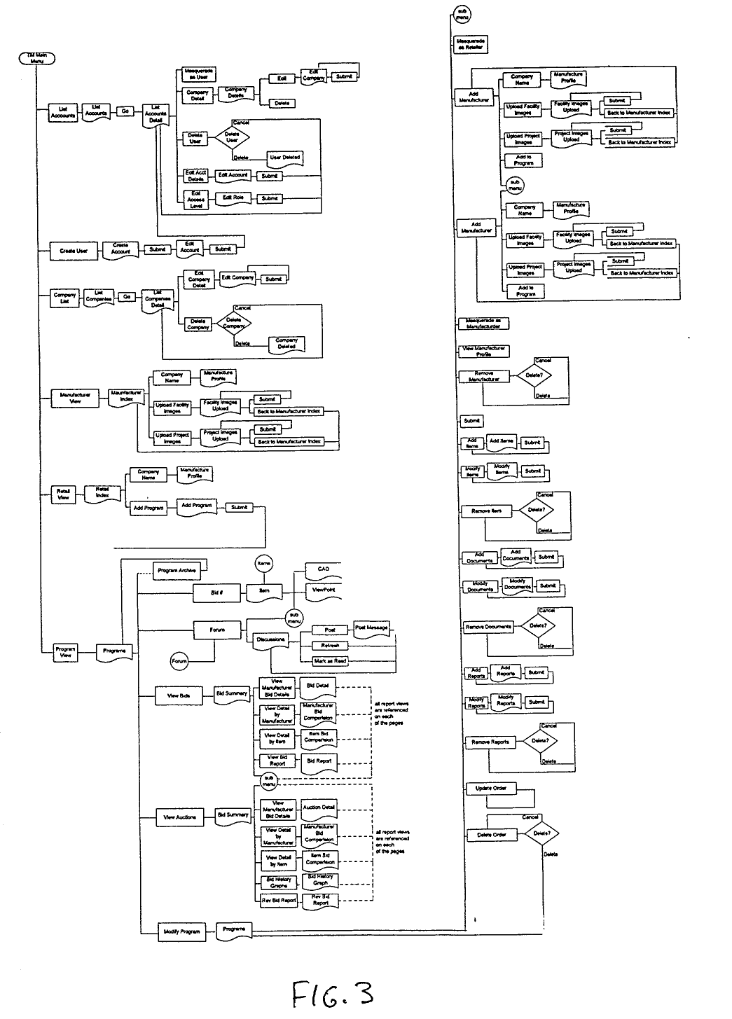

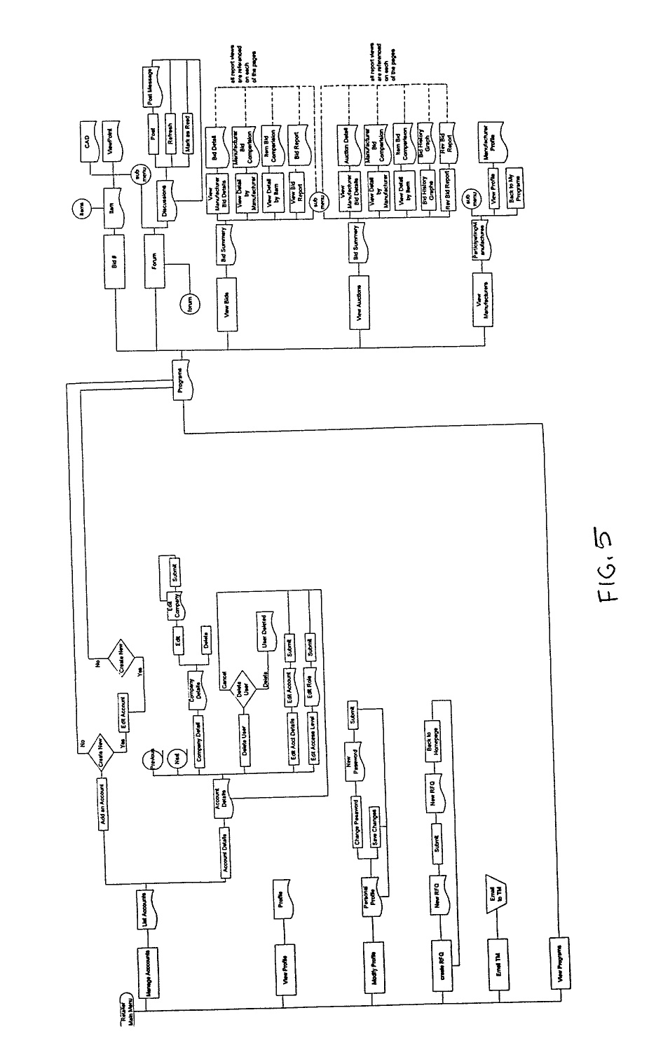

The steps of the present method are shown in the block diagram of FIG. 1. FIGS. 2, 3, 4 and 5 are explicitly detailed block diagrams depicting a plurality of linked web pages in a web site for implementing the preferred embodiment of the present invention. It should be understood that FIG. 2 shows a main sub-menu for the web site, which can be a home page for an procurement/auction web site in accordance with the present invention. FIG. 3 shows a tree of linked web pages with menu options for a transaction manager section interface as a part of the procurement/auction web site in accordance with the present invention. FIG. 4 shows a tree of linked web pages with menu options for a seller section web page interface as a part of the procurement/auction web site in accordance with the present invention. FIG. 5 shows a tree of linked web pages with menu options for a buyer section web page interface as a part of the procurement/auction web site in accordance with the present invention.

As illustrated, the present invention includes a method and implementation of management for procurement bidding, including the steps as follows hereinbelow. A “request for quote” (RFQ) is received including requirement information from a buyer for a specific transaction. The specific transaction can be any type of business transaction, preferably business-to-business, where goods and services to be provided from one or more sellers to the buyer. For example, the goods and services can include products to be manufactured, non-resale retail items such as retail fixtures (display cases, etc.) and other products such as copy paper and shopping bags. Downstream services can also include shipping services, full program management, product design, site surveys, storage/warehousing services, general construction services, security services, fixtures, displays, graphics products and services, logistic management and consolidation, B2B procurement, fixture design and installation and merchandising. The present method can also provide a sub-market for manufacturers to purchase raw materials, such as supplies, building materials, metal, laminate, wood, hardware, glass, plexi-glass, flooring, paint, etc. The RFQ and requirement information is preferably received by a specific individual, who can be a transaction manager or facilitator, who manages the implementation of the present method. The RFQ and required information can be submitted in soft copy received in a direct email, or in any other means for transferring soft copy files, preferably received from input fields on a suitable web page for submitting information as well as hard copy, through fax or postal mail. The submitted information can include any type of goods and services specifications, including technical parameters and engineering details, if appropriate, and also any deadlines with respect to the transaction. As needed, the information can be supplemented through personal and/or telephonic communication between the buyer and the transaction manager. Such communication helps establish the buyer's philosophy, goals and timeline of the project to fully develop the RFQ.

Upon receipt of the information from the buyer, the requirement information is packaged into a bid/auction presentation for the predetermined transaction. Preferably, this packaging step is performed electronically to produce an auction presentation that can be electronically viewed and retrieved by potential sellers over a web page. The auction presentation is preferably generated in a standardized format that can include descriptions of the goods and services, any specifications or technical parameters, and any required deadlines. To further communicate the needs of the sellers, the auction presentation can be supplemented with static and interactive graphical renderings of the goods and services required. This presentation is prepared as an additional service on the transaction manager side and can be prepared as a design project using computer tools such as AutoCad, 3-D Studio Max, PhotoShop, Viewpoint, ChartFX, Flash, and Crystal Reports, or any other comparable computer design tools such as are known to those skilled in the art. The resulting graphics can include interaction views of a product to be produced, and can include animations, and fully rotatable and explodable views of the product. Also, these options can be depicted as “wireframe” objects, or fully developed three-dimensional objects. The seller approves the bid/auction presentation prior to commencement of the procurement process.

After the bid/auction presentation is prepared, a step follows of selecting a plurality of sellers to each respectively provide at least one competitive bid for the predetermined transaction. The plurality of sellers are preferably pre-qualified bidders, having membership participation on the auction/procurement service. Sellers are selected from an appropriate category of an online membership database of sellers to match the requirements of the project RFQ. The database is preferably electronically retrievable and can include demographic information for the buyers and sellers, and can indicate market distribution based on service areas or other geographical segments. The database can also indicate a seller's product and service capabilities, manufacturing and equipment capabilities, logistics and freight information, and any client or trade references, such as Dun & Bradstreet rating, and financial history. The database can also include photographs of their facility and products. In the preferred embodiment, the selecting step is manually performed by a transaction manager, but it is considered that this step can optionally be automated by implementing a scheme where the buyers and sellers preselect specific goods and services category criteria. In any case, sellers are chosen to match buyer requirement information with appropriate seller expertise. The seller information can be made available to the buyer throughout the process, and can be displayed to the buyer through a web page. The buyer may choose to decline any seller at any point in the bidding process, preferably before the active bid process, at which time the declined seller is removed from the list of the plurality of sellers.

After seller selection, the bid/auction presentation is displayed for inspection to the plurality of sellers. Preferably, the presentation is posted in “open status” as password-protected program page on the procurement/auction web site. While in open status, the selected sellers are notified via email that they have qualified to participate in bidding on the bid/auction presentation. A seller may optionally choose to participate or not participate in the bidding event, but must reply in a predetermined period, e.g. 72 hours, if a seller wishes to participate. During the “open” stage, the sellers have an opportunity to view the presentation and prepare for the bidding process.

Following the step of displaying the bid/auction presentation, during the “open” stage, a step is provided of soliciting feedback from the sellers. This stage enables the sellers to provide comments so as to either request more information from the buyer or propose alternatives to the requirement information specified in the auction presentation. For example, the seller may be able to suggest a different way of making a product or providing a service. The alternatives may be able to save money through saving material costs and thereby improve efficiency, or else improve quality or otherwise add value to the goods and services. The step of soliciting feedback is preferably electronically implemented as a live, online, interactive forum where sellers input comments into a forum input web page. In the forum, information is exchanged between the buyer and the sellers in a timely and efficient manner. The comments obtained from the forum input web page are then preferably displayed on a forum output web page viewable by all of the respective plurality of sellers, while keeping the sellers' identity anonymous to other sellers. Any questions or other comments can be replied to in the forum by the buyer and/or the transaction manager. Also, the bid/auction presentation can accordingly be modified or supplemented in response to the comments and replies. The forum can optionally provide the step of enabling the sellers to input further comments into the forum input web page to provide further comments to the comments of the respective other sellers, and/or the comments of the buyer and/or transaction manager. In the forum, all sellers are participating on a level playing field as they receive the same information from the buyer at the same times. As the presentation may be modified throughout the forum stage, the buyers reap the benefit of group engineering through supplier's use of the forum.

After the forum stage, the status is changed to “closed.” Before the bid/auction is open for bidding, an optional step may be provided of soliciting a closed bid from each of the plurality of sellers. During this stage, the sellers may modify their closed bids upwards or downwards as many times as they wish, but without seeing the other closed bids. At any point during this stage, or after a predetermined period that ends this stage, the buyer may choose to select a winning bid from one of the closed bids posted by the sellers. Alternatively, one or more of these closed bids can be used to establish an opening auction bidding level to be used at the commencement of an open reverse auction to extend for a predetermined auction interval.

In another aspect of the invention, the “closed bid” steps may optionally not be employed. After the forum stage, sellers may proceed to the open reverse auction. Before the open auction commences, a step is provided for establishing a suitable bid decrement to be used by the plurality of sellers in submitting competitive bids. The decrement may be selected by one or both of the buyer or the transaction manager. In this way, bidding is set at an appropriate level for the cost and requirements of the goods and services, so as to insure value for the buyer and a profit incentive for the seller.

After the bidding parameters have been defined, the status is changed to “auction” status and the sellers are notified and are now able to submit their bids by inputting data on template web pages via the web site. In the reverse auction stage, the sellers must submit increasingly lower bids with amounts equal to or greater than the amount established as the bid decrement. The auction is moderated for a predetermined auction interval to enable the plurality of sellers to submit a plurality of competitive bids. The seller and/or the transaction manager are provided with an electronic interface such as a web page for monitoring the progress of the auction.

At such a time as the auction is completed, the bid results are presented to the buyer for selection of a winning bid from among the sellers. The bid results can be presented as one or more reports that can show the auction history, seller input, and seller comment history. The reports can include comparison data and can be presented graphically to enable the buyer to select a seller based on the best pricing, quality or other criteria associated with the seller's profile. The lowest bid need not be the winning bid. For example, it may turn out that the lowest bid may not be sufficiently close geographically, and e.g. shipping costs would add to the cost. Thus, the buyer can select the winning bid based on any fair basis.

As additional services, the web site provider can execute the payment processing and manages inventory for the buyers and sellers. The web site provider and/or an affiliate can also execute additional services beyond the procurement process. Fees for services can be applied to all goods and services procured through the web site, and can be based on a per project basis, monthly or annual basis. The web site provider can provide complete execution of an RFQ in house, encompassing design, development, seller qualification, forum access, bidding/auction management, online catalog, payment processing, inventory management and bid dispute resolution, as such services would be required.

As disclosed, the present invention includes several important features including reporting tools, administration of bidding, auction and catalog management, guidelines for the configuration of application and hardware, web user tools, inventory and package tracking, search engine capabilities, a downloading data capability, client history tracking, and disclaimers and warranties. The invention can optionally be licensed to customers so they may utilize the bidding/auction engine of the present invention to handle their own procurement needs. The invention can be fully integrated with the customers' purchasing system, and can be implemented on many platforms including IBM, SAP, Oracle, Lotus and others. Also, the invention may be deployed as a software development package to customers so they may configure and implement the design, development, seller qualification, forum, bidding/auction, online catalog, payment process and inventory management in-house. The tool could include a system architecture and software package, data exchange tool with customer systems, full access to bidding/auction and catalog engine, execution of customer's own additions and changes, and management tools for customization of software. A subscription service can be extended to offer upgrades on a periodic basis.

As disclosed, the invention incorporates database and analysis applications with comprehensive AutoCAD and design services, along with real-time online collaboration, customer service functions, and security technologies, so as to provide an inline link between buyers and domestic and international suppliers, thereby providing a faster to-market time for buyers, thereby cutting costs and time spent procuring corporate expenditures. The invention can also be adapted to provide adjacent services such as an e-commerce catalog, a reverse auction and online conferencing options to support the business development and procurement processes. Also, a specific buyer may generate an RFQ as a single participant or combine with other buyers to enhance their collective buying power, thereby “closing the chain” to create a resource critical to all parties in the business development process, providing additional value, economy and profit for all parties involved, enabling savings to be passed along to the bottom line to remain competitive in the marketplace.

As described hereinabove, the present invention therefore solves many problems associated with previous type methods and implementations associated with procurement of goods and services. However, it will be appreciated that various changes in the details, materials and arrangements of parts which have been herein described and illustrated in order to explain the nature of the invention may be made by those skilled in the art within the principle and scope of the invention will be expressed in the appended claims.

I claim:

1. A method of management for procurement bidding comprising the steps of:
receiving a request for quote including requirement information from a buyer for a predetermined transaction;
packaging the requirement information into a bid/auction presentation for the predetermined transaction;
selecting a plurality of sellers to each respectively provide at least one competitive bid for the predetermined transaction;
displaying the bid/auction presentation for inspection to the plurality of sellers;
moderating a bid/auction for a predetermined interval to enable the plurality of sellers to submit a plurality of competitive bids; and
presenting bid results to the buyer for selection of winning bid from among the sellers.

2. The method of claim 1 wherein the predetermined transaction comprises at least one of goods and services to be provided from at least one of the sellers to the buyer.

3. The method of claim 2 wherein the goods and services are selected from a group including at least one of: products to be manufactured, non-resale retail items, shipping services, storage/warehousing services, general construction services, security services, fixtures, displays, design, installation, merchandising services, graphics products and services, supplies, building materials.

4. The method of claim 1 wherein the step of receiving required information comprises receiving information on at least one of specifications, technical parameters, and deadlines with respect to the predetermined transaction.

5. The method of claim 1 wherein the step of packaging the requirement information comprises generating a bid/auction presentation in a standardized format including at least one of descriptions, specifications, technical parameters, deadlines, and static and interactive graphical renderings with respect to the predetermined transaction.

6. The method of claim 1 wherein the step of selecting a plurality of sellers comprises selecting sellers from an appropriate category of a membership database of sellers so as to match buyer requirement information with appropriate seller expertise.

7. The method of claim 1 wherein, following the step of displaying the bid/auction presentation, a step is provided of soliciting feedback so as to enable the sellers to provide comments with at least one of requesting more information and proposing alternatives to the requirement information specified in the auction presentation.

8. The method of claim 7 wherein the comments obtained from the step of soliciting feedback are made available to all of the respective plurality of sellers, and wherein the step of soliciting feedback is repeated to enable the sellers to provide further comments on each other's comments.

9. The method of claim 1 wherein, prior to the step of moderating an auction, a step is provided for soliciting a closed bid from each of the plurality of sellers, wherein the solicited closed bids establish an opening auction bidding level prior to the predetermined auction interval.

10. The method of claim 1 wherein, prior to the step of moderating an auction, a step is provided for establishing a predetermined bid decrement to be used by the plurality of sellers in submitting competitive bids.

11. The method of claim 1 wherein the step of presenting bid results comprises presenting at least one report selected from at least one of: bid/auction history, seller input, and seller comment history.

12. The method of claim 1 wherein the steps of displaying the bid/auction presentation for inspection to the plurality of sellers and moderating a bid/auction for a predetermined auction interval are performed electronically over a network.

13. The method of claim 12 wherein the steps of displaying the bid/auction presentation for inspection to the plurality of sellers and moderating a bid/auction for a predetermined auction interval are performed electronically over an Internet connection.

14. The method of claim 12 wherein the step of receiving a request for quote including requirement information from a buyer and the step of presenting bid results to the buyer are performed electronically over a network.

15. The method of claim 12 wherein the step of packaging the requirement information into a bid/auction presentation comprises producing the bid/auction presentation in an electronically retrievable format so as to enable electronic retrieval of the bid/auction presentation by the plurality of sellers over the network.

16. The method of claim 12 wherein the step of selecting a plurality of sellers comprises selecting sellers from an electronically retrievable database of sellers.

17. A web-based method of management for procurement bidding comprising the steps of:
receiving requirement information from a buyer for a predetermined transaction;
electronically displaying the requirement information on a web page as a bid/auction presentation for inspection by a plurality of sellers;
utilizing an electronic interface to moderate a bid/auction based on the bid/auction presentation for a predetermined interval;
electronically enabling the plurality of sellers to input a plurality of competitive bids on the bid/auction presentation into a web page; and
electronically presenting bid results to the buyer for selection of winning bid from among the sellers.

18. The web-based method of claim 17 wherein the predetermined transaction comprises at least one of goods and services to be provided from at least one of the sellers to the buyer.

19. The web-based method of claim 18 wherein the goods and services are selected from a group including at least one of: products to be manufactured, non-resale retail items, shipping services, storage/warehousing services, general construction services, security services, fixtures, displays, design, installation, merchandising services, graphics products and services, supplies, building materials.

20. The web-based method of claim 17 wherein the step of receiving required information comprises electronically receiving the information from input fields on a web page for submitting information on at least one of: specifications, technical parameters, and deadlines with respect to the predetermined transaction.

21. The web-based method of claim 17 further comprising the step of electronically packaging the requirement information into the bid/auction presentation for the predetermined transaction.

22. The web-based method of claim 21 wherein the step of electronically packaging the requirement information comprises the step of generating a bid/auction presentation in a standardized format including at least one of descriptions, specifications, technical parameters, deadlines, and static and interactive graphical renderings with respect to the predetermined transaction.

23. The web-based method of claim 17 further comprising an electronically selecting a plurality of sellers to each respectively provide at least one competitive bid for the predetermined transaction.

24. The web-based method of claim 23 wherein the step of electronically selecting a plurality of sellers comprises selecting sellers from an appropriate category of a membership database of sellers so as to match buyer requirement information with appropriate seller expertise.

25. The web-based method of claim 17 further comprising the step of electronically enabling the plurality of sellers to input comments into a forum input web page with at least one of requesting more information and proposing alternatives to the requirement information specified in the bid/auction presentation.

26. The web-based method of claim 25 further comprising the step of displaying the comments obtained from the forum input web page on a forum output web page viewable by all of the respective plurality of sellers, and further comprising the optional step of electronically enabling the plurality of sellers to input further comments into the forum input web page to provide further comments to the comments of the respective other sellers.

27. The web-based method of claim 17 further comprising the step of electronically soliciting the plurality of sellers to input a closed bid into a web page, wherein the solicited closed bids are displayed which can be used to establish an opening auction bidding level prior to the predetermined auction interval.

28. The web-based method of claim 17 wherein the step of utilizing an electronic interface to moderate an auction comprises establishing a predetermined bid decrement to be used by the plurality of sellers in submitting competitive bids.

29. The web-based method of claim 17 wherein the step of electronically presenting bid results comprises means for displaying at least one report selected from at least one of: auction history, seller input, and seller comment history.

30. An electronic implementation for management of a network-based procurement bidding comprising:
an electronic interface for displaying requirement information from a buyer as a bid/auction presentation for inspection by a plurality of sellers;
an electronic interface for allowing a transaction manager to moderate a bid/auction based on the bid/auction presentation for a predetermined auction interval;
an electronic interface for enabling the plurality of sellers to submit a plurality of competitive bids on the auction presentation; and
an electronic interface for presenting bid results to the buyer for selection of winning bid from among the sellers.

31. The implementation of claim 30 wherein the predetermined transaction comprises at least one of goods and services to be provided from at least one of the sellers to the buyer.

32. The implementation of claim 31 wherein the goods and services are selected from a group including at least one of: products to be manufactured, non-resale retail items, shipping services, storage/warehousing services, general construction services, security services, fixtures, displays, design, installation, merchandising services, graphics products and services, supplies, building materials.

33. The implementation of claim 30 further comprising an electronic interface for initially submitting the requirement information from a buyer for a predetermined transaction, wherein the interface for submitting required information comprises input fields for submitting information on at least one of: specifications, technical parameters, and deadlines with respect to the predetermined transaction.

34. The implementation of claim 30 further comprising an electronic implementation for enabling the transaction manager to package the requirement information into the auction presentation for the predetermined transaction, wherein the transaction manager is at least one of a web site provider, a third party representative, and a representative from the buyer's company.

35. The implementation of claim 34 wherein the implementation for packaging the requirement information comprises means for generating a bid/auction presentation in a standardized format including at least one of descriptions, specifications, technical parameters, deadlines, and static and interactive graphical renderings with respect to the predetermined transaction.

36. The implementation of claim 30 further comprising an electronic interface for selecting a plurality of sellers to each respectively provide at least one competitive bid for the predetermined transaction;

37. The implementation of claim 36 wherein the interface for selecting a plurality of sellers comprises means for selecting sellers from an appropriate category of a membership database of sellers so as to match buyer requirement information with appropriate seller expertise.

38. The implementation of claim 30 further comprising an electronic forum including an electronic interface for inputting comments from the sellers with at least one of requesting more information and proposing alternatives to the requirement information specified in the bid/auction presentation.

39. The implementation of claim 38 further comprising an electronic interface for displaying the comments obtained from the electronic forum to all of the respective plurality of sellers, and wherein the electronic interface for inputting comments enables the sellers to provide further comments on each other's comments.

40. The implementation of claim 30 further comprising an electronic interface for soliciting a closed bid from each of the plurality of sellers, wherein the solicited closed bids establish an opening auction bidding level prior to the predetermined reverse auction interval.

41. The implementation of claim 30 wherein the electronic interface for moderating an auction comprises an implementation for establishing a predetermined bid decrement to be used by the plurality of sellers in submitting competitive bids.

42. The implementation of claim 30 wherein the electronic interface for presenting bid results comprises means for displaying at least one report selected from at least one of: auction history, seller input, and seller comment history.

43. The implementation of claim 30 wherein the electronic implementation for management of a network-based bid/auction is deployed electronically over an Internet connection.
